(19) United States
(12) Patent Application Publication
(10) Pub. No.: US 2015/0134502 A1
(43) Pub. Date: May 14, 2015

(54) Method and System for Aggregating Company Information

(71) Applicant: Bank of America Corporation, Charlotte, NC (US)

(72) Inventors: Ashu Chugh, Haryana (IN); Vivek Singh, Delhi (IN); Robin Mailk, Haryana (IN); Vandana Mayne, New Delhi (IN)

(73) Assignee: Bank of America Corporation, Charlotte, NC (US)

(21) Appl. No.: 14/079,115

(22) Filed: Nov. 13, 2013

(51) Int. Cl. G06Q 40/04

(52) U.S. Cl. CPC G06Q 40/04
USPC 705/37

(57) ABSTRACT

In an embodiment, a method for aggregating company information includes receiving a request from a user to obtain information associated with a company, aggregating, by one or more processing devices, the information associated with the company from a plurality of websites in real time without caching any data associated with the information. The information includes a news story associated with the company. The method further includes analyzing, by the one or more processing devices, the information by performing a plurality of calculations using the information. The plurality of calculations include a plurality of financial ratios. The method further includes categorizing, by the one or more processing devices, the news story associated with the company into one or more of a plurality of news categories, creating a profile associated with the company based on the information, and communicating the profile associated with the company to the user.

### TECHNICAL FIELD

This invention relates generally to information aggregators, and more particularly to a method and system for aggregating company information.

### BACKGROUND

An enterprise may have a relationship with a company. Some enterprises may desire to keep track of a variety of factors affecting the company. Because some large enterprises may have relationships with several thousand companies, keeping track of all companies and all factors affecting the companies can be complex and time consuming.

### SUMMARY OF EXAMPLE EMBODIMENTS

According to embodiments of the present disclosure, disadvantages and problems associated with previous techniques for aggregating company information may be reduced or eliminated.

In an embodiment, a method includes receiving a request from a user to obtain information associated with a company and aggregating the information associated with the company from a plurality of websites in real time without caching any data associated with the information. The information may include a news story associated with the company. The method further includes analyzing the information by performing a plurality of calculations using the information. The calculations may include a plurality of financial ratios. The method further includes categorizing the news story associated with the company into one or more of a plurality of news categories, creating a profile associated with the company based on the information, and communicating the profile associated with the company to the user.

Particular embodiments of the present disclosure may provide one or more technical advantages. For example, certain embodiments of the present disclosure may aggregate company information in real time, which may provide users with the most up-to-date company information. As another example, an embodiment of the present disclosure may aggregate company information from multiple sources, which may provide for a more comprehensive and accurate company profile. As yet another example, certain embodiments of the present disclosure may aggregate company information without caching any data associated with the information, which may conserve system resources. As still yet another example, an embodiment of the present disclosure may categorize a news story associated with the company into one or more of a plurality of news categories thereby providing an efficient overview of various news stories related to the company. Because a user is efficiently presented with various news categories from which to select, the user may save time and resources searching for certain news articles associated with a company.

Certain embodiments of the present disclosure may include some, all, or none of the above advantages. One or more other technical advantages may be readily apparent to those skilled in the art from the figures, descriptions, and claims included herein.

### BRIEF DESCRIPTION OF THE DRAWINGS

For a more complete understanding of the present disclosure, and for further features and advantages thereof, reference is now made to the following description taken in conjunction with the accompanying drawings, in which:

FIG. 1 is a block diagram illustrating an example system for aggregating company information, according to certain embodiments of the present disclosure;

FIG. 2 is a flow chart illustrating an example method for aggregating company information, according to certain embodiments of the present disclosure; and

FIG. 3 illustrates an example graphical user interface, according to certain embodiments of the present disclosure.

### DETAILED DESCRIPTION

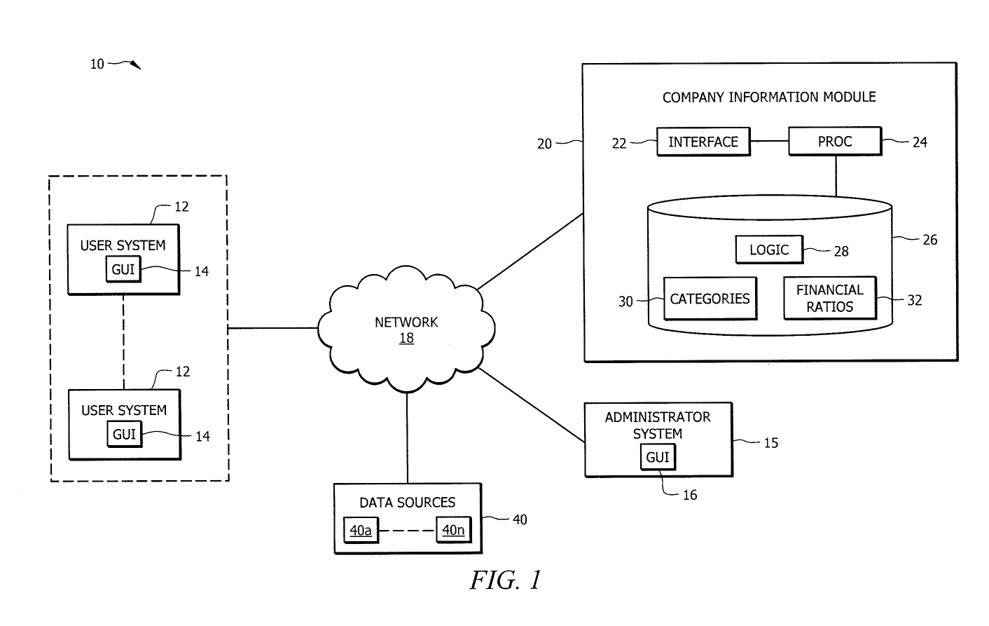

Embodiments of the present disclosure and their advantages are best understood by referring to FIGS. 1 through 3 of the drawings, like numerals being used for like and corresponding parts of the various drawings.

Large enterprises may have relationships with thousands of different companies. Since an enterprises' relationship with a particular company may affect the enterprises' own business, an enterprise may wish to track each company, such as by tracking a company's financial performance, news associated with the company, a company's stock price, competitors of the company, or a company's executives. However, there are several problems associated with tracking a large number of companies. First, tracking several thousand companies can consume vast resources. Second, due to the dynamic nature of information in today's economy, information quickly becomes out of date. Third, there are a vast number of information resources available such that aggregating information on a particular company to provide a comprehensive company profile would be time consuming. To solve these problems, an enterprise may aggregate information associated with a company in real time (e.g., “on-the-fly” each time a request for the information is received) from a plurality of data sources.

FIG. 1 illustrates an example system 10 for aggregating company information, according to certain embodiments of the present disclosure. System 10 may include user system 12, administrator system 15, network 18, company information module 20, and data sources 40. User system 12 may include graphical user interface (GUI) 14, and administrator system 15 may include graphical user interface (GUI) 16. Company information module 20 may include interface 22, processor 24, and memory 26. User system 12 may be configured to communicate with company information module 20 via network 18. Administrator system 15 may be configured to communicate with company information module 20 via network 18. Company information module 20 may be configured to communicate with data sources 40 via network 18. Although this particular implementation of system 10 is illustrated and primarily described, the present disclosure contemplates any suitable implementation of system 10 according to particular needs.

Generally, system 10 is operable to aggregate company information from a plurality of data sources 40 in real time. The aggregated company information may be used to generate a company profile, which may provide a user of user system 12 with a comprehensive overview of a particular company. For example, a company profile may include a list of executives and a description of the company. As another example, the company profile may include various news categories that list news stories associated with the particular company according to the various categories. As yet another example, the company profile may provide a user of user system 12 with financial details of the company, such as a stock quote, financial ratios, or financial graphs. As still yet another example, the company profile may include a competitive analysis that displays the company's competitors according to particular market segments. Once the company profile is generated, the profile is communicated to user system 12 via network 18. The company profile may then be displayed on GUI 14 of user system 12.

User system 12 may include any suitable device or combination of devices operable to allow a user (e.g., an enterprise employee or other authorized personnel) to access all or a portion of the functionality associated with company information module 20 (as described in detail below). For example, user system 12 may include one or more computer systems at one or more locations. A computer system, as used herein, may include a personal computer, workstation, network computer, kiosk, wireless data port, personal data assistant (PDA), one or more processors within these or other devices, or any other suitable processing device. Additionally, each computer system may include any appropriate input devices (such as a keypad, touch screen, mouse, or other device that can accept information), output devices, mass storage media, or other suitable components for receiving, processing, storing, and communicating data. Both the input device and output device may include fixed or removable storage media, such as a magnetic computer disk, CD-ROM, or other suitable media. User system 12 includes GUI 14 in certain embodiments.

GUI 14 may be delivered using an online portal, hypertext mark-up language (HTML) pages for display and data capture, or in any other suitable manner. GUI 14 may allow a user of user system 12 to interact with other components of system 10. For example, GUI 14 may allow a user of user system 12 to access all or a portion of the functionality associated with company information module 20 (as described in further detail below). The present disclosure contemplates that system 10 may include any suitable number of user systems 12, according to particular needs.

User system 12 may be communicatively coupled to company information module 20 via network 18. Network 18 may facilitate wireless or wireline communication and may communicate, for example, IP packets, Frame Relay frames, Asynchronous Transfer Mode (ATM) cells, voice, video, data, and other suitable information between network addresses. Network 18 may include one or more local area networks (LANs), radio access networks (RANs), metropolitan area networks (MANs), wide area networks (WANs), all or a portion of the global computer network known as the Internet, and/or any other communication system or systems at one or more locations.

Administrator system 15 may include any suitable device or combination of devices operable to allow a user (e.g., an enterprise employee or other authorized personnel) to access all or a portion of the functionality associated with company information module 20 (as described in detail below). For example, administrator system 15 may include one or more computer systems at one or more locations as described above with respect to user system 12. Administrator system 15 may include GUI 16 as described above with respect to GUI 14 in an embodiment. For example, GUI 16 may allow an administrator of administrator system 15 to access all or a portion of the functionality associated with company information module 20 (as described in further detail below). Administrator system 15 may be communicatively coupled to company information module 20 via network 18 as described above with respect to user system 12. The present disclosure contemplates that system 10 may include any suitable number of administrator systems 15, according to particular needs.

Administrator system 15 is operable to configure company information module 20 in certain embodiments. For example, administrator system 15 may define the websites from which company information module 20 aggregates company information. As another example, administrator system 15 may define various algorithms used to calculate financial ratios. As yet another example, administrator system 15 may add or remove news categories. As still yet another example, administrator system 15 may add or remove fields in the company profile, such as by adding a field that displays recent video segments from a financial television channel.

Company information module 20 represents any suitable component that facilitates receiving requests for information associated with a company, aggregating the information from data sources 40, analyzing the information, creating a company profile, and communicating the company profile to user system 12 via network 18. Company information module 20 may include a network server, any suitable remote server, a mainframe, a host computer, a workstation, a web server, a personal computer, a file server, or any other suitable device operable to communicate with user system 12, administrator system 15, network 18, and data sources 40. In some embodiments, company information module 20 may execute any suitable operating system, such as IBMs, Z Series/Operating System (Z/OS), MS-DOS, PC, DOS, MAC-OS, Windows, Unix, Open VMS, or any other appropriate operating system including future operating systems. The functions of company information module 20 may be performed by any suitable combination of one or more servers or other components at one or more locations. In the embodiment where company information module 20 is a server, the server may be a private server or the server may be a virtual or physical server. The server may include one or more servers at the same or remote locations. Also, company information module 20 may include any suitable component that functions as a server. In the illustrated embodiment, company information module 20 includes network interface 22, processor 24, and memory 26.

Network interface 22 represents any suitable device operable to receive information from network 18, transmit information through network 18, perform processing of information, communicate with other devices, or any combination of the preceding. For example, network interface 22 may receive a request for information associated with a company from user system 12 over network 18. As another example, network interface 22 may receive data associated with company information from data sources 40 over network 18. As yet another example, network interface 22 may receive one or more instructions from administrator system 15 over network 18. As still yet another example, network interface 22 may communicate a company profile to user system 12 over network 18. Network interface 22 represents any port or connection, real or virtual, including any suitable hardware and/or software including protocol conversion and data processing capabilities to communicate through a LAN, a WAN, a MAN, or other communication systems that allow company information module 20 to exchange information with user system 12, administrator system 15, network 18, or data sources 40.

Processor 24 communicatively couples to network interface 22 and memory 26 and controls the operation and administration of company information module 20 by processing information received from network interface 22 and memory 26. Processor 24 includes any hardware and/or software that operates to control and process information. For example, processor 24 executes logic 28 to control the operation of company information module 20. Processor 24 may be a programmable logic device, a microcontroller, a microprocessor, any suitable processing device, or any suitable combination of the preceding.

Memory 26 stores, either permanently or temporarily, data, operational software, or other information for processor 24. Memory 26 includes any one or a combination of volatile or nonvolatile, local or remote devices suitable for storing information. For example, memory 26 may include RAM, ROM, magnetic storage devices, optical storage devices, or any other suitable information storage device, or a combination of these devices. While illustrated as including particular modules, memory 26 may include any suitable information for use in the operation of company information module 20. In the illustrated embodiment, memory 26 includes logic 28, categories 30, and financial ratios 32.

Logic 28 generally refers to logic, rules, algorithms, code, tables, and/or other suitable instructions embodied in a computer readable storage medium for performing the described functions and operations of company information module 20. For example, logic 28 facilitates the aggregation of information associated with a company from data sources 40 in real time. As another example, logic 28 facilitates the analysis of the information by performing a plurality of calculations using the information, such as calculating various financial ratios. As yet another example, logic 28 facilitates the categorization of news stories into various categories. As still yet another example, logic 28 facilitates the creation of a profile associated with the company based on the information.

Memory 26 includes categories 30 in an embodiment. In certain embodiments, categories 30 may be stored in a database, such as, for example, a Microsoft Access® database. In other embodiments, categories 30 may be stored in a Microsoft Excel® spreadsheet. In certain embodiments, categories 30 may include any number of the following news categories: earnings releases, mergers and acquisitions, executives and board, awards and recognitions, new contracts, and other news. The earnings release category may include news associated with a company's announcement of financial results for any calendar period (quarterly, annually, etc.). The mergers and acquisitions category may include news associated with recent takeovers, mergers, or consolidations in which the company is involved. The executives and board category may include news associated with any managerial or board changes, such as an appointment or departure. The awards and recognitions category may include news associated with an accolade or recognition that the company received. The new contracts category may include news associated with contracts, extensions, or other business wins affecting the company. The other news category may capture all other news associated with the company. In an embodiment, the news categories are predefined by an administrator using administrator system 15. In an embodiment, an administrator may add or remove news categories using administrator system 15. Although particular categories have been discussed as examples, company information module 20 contemplates using any category.

Memory 26 includes financial ratios 32 in certain embodiments. Financial ratios 32 may be used to perform calculations using at least a portion of the information aggregated from data sources 40. For example, data sources 40 may aggregate various financial data, such as the company's revenue for the current year and revenue for the previous year. Based on that information, company information module 20 may calculate the company's revenue growth. Company information module 20 may then include that financial ratio in the company's profile. Because various financial ratios are automatically computed using up-to-date information, company information module 20 presents accurate information to a user of user system 12. In certain embodiments, an administrator predefines the financial ratios using administrator system 15. In some embodiments, an administrator can add or remove financial ratios using administrator system 15. In an embodiment, financial ratios 32 include any of the following:

| Metric | Financial Ratio |
|---|---|
| Revenue Growth | (Revenue for Current Year − Revenue for |
| | Previous Year)/Revenue for Previous Year |
| Operating Income | (Operating Income for Current Year − Operating |
| Growth | Income for Previous Year)/Operating Income for |
| | Previous Year |
| Net Income Growth | (Net Income for Current Year − Net Income for |
| | Previous Year)/Net Income for Previous Year |
| Gross Profit Margin | Gross Profit/Revenue * 100 |
| Operating Profit | Operating Profit/Revenue * 100 |
| Margin | |
| Net Profit Margin | Net Profit/Revenue * 100 |
| Effective Tax Rate | Income Tax Expense/Income Before Tax * 100 |
| Return on Assets | Net Income/Total Assets * 100 |
| Return on Equity | Net Income/Total Stockholder Equity * 100 |
| Net Working Capital | Total Current Assets − Total Current Liabilities |
| Current Ratio | Total Current Assets/Total Current Liabilities |
| Quick Ratio | (Total Current Assets − Inventory)/Total Current |
| | Liabilities |
| Cash Ratio | Cash and Cash Equivalents/Total Liabilities |
| Debt Ratio | Total Liabilities/Total Assets |
| Debt-Equity Ratio | Total Liabilities/Total Stockholder Equity |
| Interest Coverage | Interest Expense/Earnings before Interest and |
| Ratio | Taxes (EBIT) |
| Cash Flow to Debt | Total Cash Flow from Operating Activities/ |
| Ratio | (Current Portion of Long Term Debt + Long |
| | Term Debt) |
| Operating Cash | Total Cash Flow from Operating Activities/ |
| Flow/Sales | Revenue |
| Free Cash | (Total Cash Flow from Operating Activities − |
| Flow/Operating Cash | Capital Expenditure)/Total Cash Flow from |
| | Operating Activities |
| Short Term Debt | Total Cash Flow from Operating Activities/ |
| Coverage | Current Portion of Long Term Debt |
| Capital Expenditure | Total Cash Flow from Operating Activities/ |
| Coverage | Capital Expenditure |

System 10 includes data sources 40 in an embodiment. Generally, data sources 40 may be any source that includes information associated with a particular company. Data sources 40 may be any collection of structured and/or unstructured data in an embodiment. For example, data sources 40 may be a text file, a web page, a database, a spreadsheet, a document, an inventory flat file, a data warehouse, a machine configuration file, or any other suitable source of information. Data sources 40 may include data from a source internal or external to the enterprise in an embodiment. Data from data sources 40 is communicated to company information module 20 over network 18 in real time. For example, when company information module 20 receives a request from user system 12 for information associated with a company, company information module 20 may aggregate information from data sources 40 in response to the request (i.e., company information module 20 reaggregates company information each time it receives a request from user system 12).

Data sources 40, as noted above, may include a website in an embodiment. For example, data sources 40 may include a website operated by a government entity. As another example, data sources 40 may include a company's own website. As yet another example, data sources 40 may include a news website or a financial website. In an embodiment, an administrator of administrator system 15 predefines data sources 40. For example, an administrator of administrator system 15 can predefine data sources 40 to include 1) a government operated website, 2) a company's website, and/or 3) a financial news website. Although particular websites are described, company information module 20 may aggregate information from any website or any information source. In an embodiment, company information module 20 aggregates information associated with a company from plurality of data sources (40a-40n). For example, company information module 20 may aggregate news stories from five different news websites. Utilizing data from a variety of different sources provides a more comprehensive and accurate company profile.

As an example embodiment of operation of system 10, company information module 20 receives a request for information associated with a company from user system 12 via network 18. Company information module 20 aggregates information associated with the company from data sources 40 in real time. Company information module 20 analyzes the information by performing a plurality of calculations using the information. The plurality of calculations may include financial ratios 32. Company information module 20 categorizes news stories associated with the company using categories 30. Company information module 20 creates a profile associated with the company based on the information and communicates the profile to user system 12. The profile may then be displayed on user system 12 using GUI 14.

A component of system 10 may include an interface, logic, memory, and/or other suitable element. An interface receives input, sends output, processes the input and/or output and/or performs other suitable operations. An interface may comprise hardware and/or software. Logic performs the operation of the component. For example, logic executes instructions to generate output from input. Logic may include hardware, software, and/or other logic. Logic may be encoded in one or more tangible media, such as a computer-readable medium or any other suitable tangible medium, and may perform operations when executed by a computer. Certain logic, such as a processor, may manage the operation of a component. Examples of a processor include one or more computers, one or more microprocessors, one or more applications, and/or other logic.

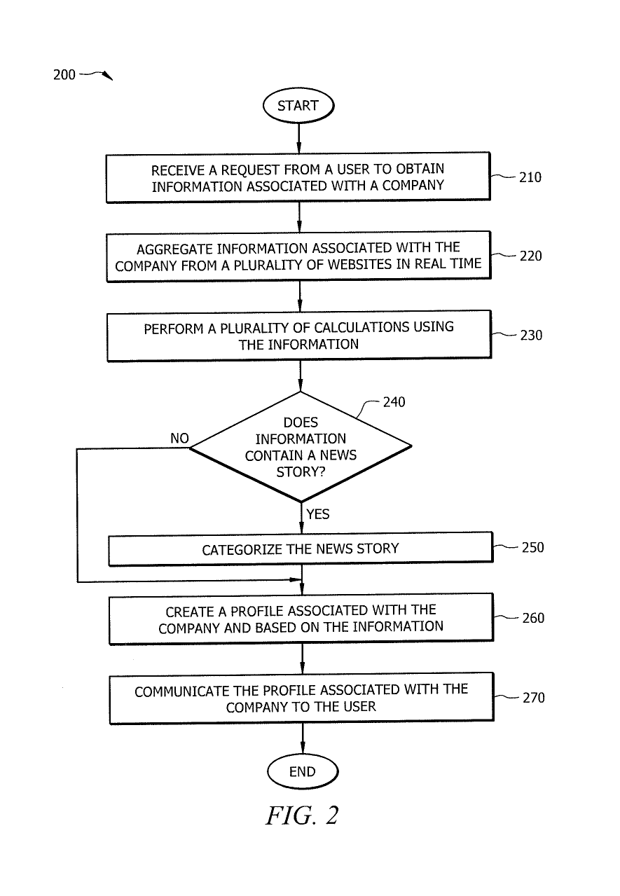

FIG. 2 is a flow chart illustrating an example method 200 for aggregating company information, according to certain embodiments of the present disclosure. Method 200 begins at step 210. At step 210, company information module 20 receives a request from a user of user system 12 to obtain information associated with a company. As described below, the request may be communicated to company information module 20 via network 18 in response to a user input in GUI 14 of user system 12. In an embodiment, the information includes any of the following: a description of the company, a list of executives of the company, a stock price of the company, a news story associated with the company, a list of competitors of the company, and/or a plurality of financial data associated with the company. In an embodiment, the information may relate to a public and/or private company. The information may relate to a United States company and/or a company located in a different country in some embodiments.

At step 220, company information module 20 aggregates the information associated with the company from data sources 40 in real time. In an embodiment, real time aggregation of information may occur automatically in response to a user of user system 12 requesting company information. For example, a user may click a refresh button on GUI 14 to cause company information module 20 to update the company profile automatically (i.e., company information module 20 reaggregates the requested information from data sources 40 each time a user requests the information). In an embodiment, company information module 20 may use a company's ticker symbol to aggregate information. For example, company information module 20 may use Ticker A, which may be the ticker symbol corresponding to company A, to aggregate information from a predefined website. In certain embodiments, company information module 20 aggregates the information without caching any data associated with the information. Since no data is cached, system resources may be conserved. In an embodiment, company information module 20 aggregates the information from a plurality of data sources (40a-40n) to provide a comprehensive overview of a company.

At step 230, company information module 20 analyzes the information by performing a plurality of calculations using the information. For example, company information module 20 may use raw financial data aggregated from a company website to calculate a net profit margin ratio. In an embodiment, the plurality of calculations include a plurality of financial ratios, such as financial ratios 32, which may include at least one of the ratios described above.

At step 240, company information module 20 determines if the information includes a new story. In an embodiment, company information module 20 may make this determination based on the source of the information (e.g., whether it came from a news website). In another embodiment, company information module 20 may make the determination based on the form of the received information (e.g., whether it is in article or press release form). If the information includes a new story, method 200 proceeds to step 250 where a company information module 20 categorizes the news story into one or more of a plurality of news categories, such as categories 30. Company information module 20 may categorize the news story into a particular category based on the presence of a keyword. For example, if the news story includes the word “merger,” the story may be categorized into the “mergers and acquisitions” category. As another example, if the news story includes the word “CEO,” the story may be categorized into the “Executives and Board” category. The categorization may allow a user of user system 12 to quickly see news stories associated with the company according to particular categories. In an embodiment, categories 30 include the news categories described above. In certain embodiments, the keywords used to categorize the news story may be predefined. For example, an administrator of administrator system 15 may add additional keywords to “Executives and Board,” such as “Chief Financial Officer,” “Chief Technical Officer,” or “General Counsel.” In that example, company information module 20 may categorize news stories including any of those keywords into the “Executives and Board” category. If the information does not include a news story, method 200 proceeds to step 260.

At step 260, company information module 20 creates a profile associated with a company based on the information. In an embodiment, the profile may include various different information associated with the company, such as a description of the company, a stock quote, a list of executives of the company and their biographies, news categories associated with the company, competitors associated with the company, and financial data associated with the company. The company profile may include tables, graphs, raw data, interactive features, and any other feature.

At step 270, company information module 20 communicates the profile associated with the company to user system 12 through network 18. User system 12 may then display the company profile in GUI 14.

Method 200 illustrates an example method for aggregating company information. Modifications, additions, or omissions may be made without departing from the scope of this disclosure. Steps may be combined, modified, or deleted where appropriate, and additional steps may be added. For example, company information module 20 may receive a request from user system 12 over network 18 to export raw data associated with any portion of the company profile. Company information module 20 may communicate the requested raw data to user system 12 over network 18 in response to the request. In another embodiment, company information module 20 may communicate the raw data along with the company profile.

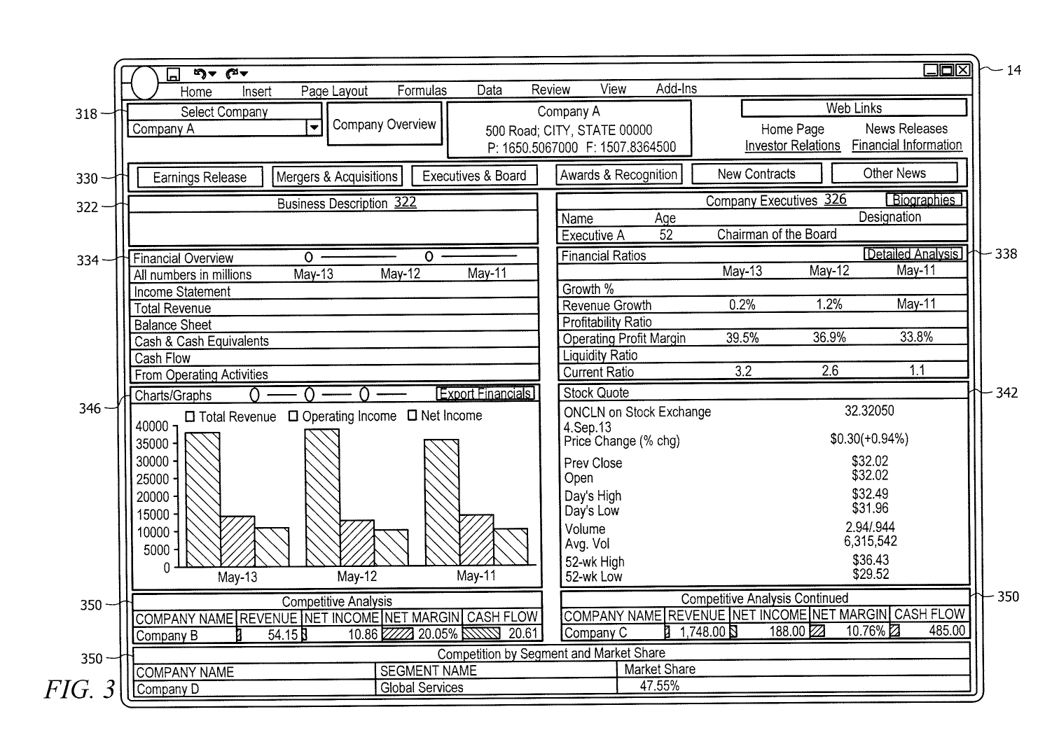

FIG. 3 illustrates an example GUI 14, according to certain embodiments of the present disclosure. GUI 14 may be any graphical user interface that allows a user to access any of the functionality associated with company information module 20. GUI 14 may include company-selection-dropdown box 318, business description field 322, company executives field 326, news category tabs 330, financial overview field 334, financial ratios field 338, stock quote field 342, graphs 346, and competitive analysis field 350 in an embodiment.

Company-selection-dropdown box 318 may allow a user of user system 12 to select company A for which the user wants information in certain embodiments. Company-selection-dropdown box 318 may list several thousand companies in an embodiment. Although company-selection-dropdown box 318 is illustrated as a dropdown box, GUI 14 may use any selection mechanism. Once a user of user system 12 selects a company from company selection dropdown box 318, a request is communicated from user system 12 to company information module 20 via network 18 for information associated with the selected company.

Business description field 322 includes an overview of the selected company in an embodiment. In some embodiments, business description field 322 may include information on the nature of the activities undertaken by the selected company. In an embodiment, business description field 322 may include historical information associated with the company. Company information module 20 may aggregate the information in business description field 322 using information from data sources 40.

Company executives field 326 may include a list of executives associated with the company in an embodiment. In some embodiments, the list of executives may include the name, age, and position of the company executives. In some embodiments, company executives field 326 may include a button operable to display biographies associated with each of the company executives. For example, if a user of user system 12 wants to view an executive's biography, the user may click a button that causes GUI 14 to display the respective executive's biography.

News category tabs 330 are operable to display a list of news stories associated with the company according to a particular category in an embodiment. The user may then select a particular story that is displayed in GUI 14 in an embodiment. In some embodiments, news category tabs 330 may include any of the following categories of news: earnings releases, mergers and acquisitions, executives and board, awards and recognition, new contracts, and other news. GUI 14 may display a list of news stories associated with a particular tab in response to a user input. For example, a user may select the earnings release tab to see all news stories associated with earnings releases of the selected company. A user input may include clicking, swiping, dragging, or hovering over a particular tab, a visual or oral indication of a particular tab, or any other user action associated with a particular tab that the user wants to select. News category tabs 330 may be configured (added, removed, modified, etc.) by an administrator of administrator system 15. For example, an administrator may add a tab for news stories related to “new products.” In an embodiment, news category tabs 330 are predefined by an administrator using administrator system 15.

Financial overview field 334 may include key metrics from a company's income statement, balance sheet, and cash flow statement in certain embodiments. For example, financial overview field 334 may display operating income and net income from the company's income statement. As another example, financial overview field 334 may display cash and cash equivalents, total assets, total liabilities, and total stockholder equity from the company's balance sheet. As yet another example, financial overview field 334 may display cash flow from operating activities, investing activities, and/or financial activities.

Financial ratios field 338 may display various financial ratios associated with a company, such as financial ratios 32 discussed above, in an embodiment. In some embodiments, financial ratios field 338 may display the calculated financial ratios from the last four quarters. In an embodiment, financial ratios field 338 may display the financial ratios calculated using the raw data received from data sources 40.

Stock quote field 342 may display up-to-date information on equities associated with a company. For example, stock quote field 342 may display a stock price, an open and close price for a particular day, the volume, the percentage change, the day's high and low price, and/or the 52-week high and low price.

Graphs 346 may be any visual indication associated with a company, such as a bar graph indicating financial performance. In certain embodiments, graphs 346 may include a button operable to change the type of graph displayed. For example, a user of user system 12 may click a button on GUI 14 to change a particular graph from a bar graph to a line graph. Graphs 346 may include graphs for total revenue, operating income, and/or net income in an embodiment. Graphs 346 may include graphs for the past four quarters in some embodiments. In other embodiments, graphs 346 may include graphs for the past three years. In an embodiment, a user of user system 12 can export the raw data associated with graphs 346.

Competitive analysis field 350 generally displays competitors of a selected company. For example, if a user of user system 12 selects company A, who manufactures widgets, from company-selection-dropdown box 318, competitive analysis field 350 may display other manufacturers of widgets. In an embodiment, the competitors may be displayed according to their market share. For example, competitive analysis field 350 may display company D along with company D's market share (e.g., 47.55% as illustrated in FIG. 3).

Company information module 20 may display the competitors of a company according to particular market segments in an embodiment. Company information module 20 may determine that a company is involved in a particular market based on information on their website or on their financial statement. For example, company A may indicate on its financial statement that it derives $20 million dollars per year from a golf club. Based on that, company information module 20 may determine that company A is in the golf club market and list other competitors of company A in the golf club market. In some situations, companies may refer to a particular segment using different names. For example, company A may refer to the vehicle market as a car market, while company B may refer to the vehicle market as the automobile market. In that situation, company information module 20 may use a list of predefined market segments so that it captures all competitors regardless of the name that the competitor uses for the segment on its financial statement. For example, an administrator of administrator system 15 may provide a list of the names that companies use to refer to a particular market segment.

In an embodiment, company information module 20 may calculate market share based on the company's total revenue for the particular market segment as a percentage of the total revenue for that market segment (e.g., the company's total revenue divided by the total revenue for the entire market segment). Company information module 20 may determine the total revenue for a market segment using predefined sources, such as an industry source.

As an example of operation of GUI 14, a user of user system 12 may select a particular company from company-selection-dropdown box 318. Once the user has selected the particular company, a request is communicated to company information module 20 over network 18. Company information module 20 communicates a company profile associated with the selected company to user system 12 via network 18. User system 12 then displays the company profile in GUI 14. A user may then interact with various features of the company profile, such as by exporting raw financial data or by loading executive biographies.

Company information module 20 may export raw data in response to request from user system 12 in an embodiment. Company information module 20 may communicate the raw data over network 18 in certain embodiments. In some embodiments, company information module 20 may communicate the raw data along with the company profile. Company information module 20 may export raw data associated with any portion of company information module 20. For example, company information module 20 may export raw data used in the calculation of financial ratios 32. As another example, company information module 20 may export raw data used to create graphs 346. As yet another example, company information module 20 may export raw data associated with stock quote field 342. In some embodiments, a user may export the raw data to a Microsoft Excel® spreadsheet. Because a user may export raw data, company information module 20 provides the benefit of allowing a user to conduct additional analysis on the data.

Particular embodiments of the present disclosure may provide one or more technical advantages. For example, certain embodiments of the present disclosure may aggregate company information in real time, which may provide users with the most up-to-date company information. As another example, an embodiment of the present disclosure may aggregate company information from multiple sources, which may provide for a more comprehensive and accurate company profile. As yet another example, certain embodiments of the present disclosure may aggregate company information without caching any data associated with the information, which may conserve system resources. As still yet another example, an embodiment of the present disclosure may categorize a news story associated with the company into one or more of a plurality of news categories thereby providing an efficient overview of various news stories related to the company. Because a user is efficiently presented with various news categories from which to select, the user may save time and resources searching for certain news articles associated with a company.

Although the present disclosure has been described with several embodiments, a myriad of changes, variations, alterations, transformations, and modifications may be suggested to one skilled in the art, and it is intended that the present disclosure encompass such changes, variations, alterations, transformations, and modifications as fall within the scope of the appended claims.

What is claimed is:

1. A system, comprising:
an interface operable to receive a request from a user to obtain information associated with a company, the information comprising:
a description of the company;
a list of executives of the company;
a stock price of the company;
a plurality of news stories associated with the company;
a list of competitors of the company, the list comprising a competitor name and a corresponding market share for each competitor according to a particular business segment; and
a plurality of financial data associated with the company;
a processor communicatively coupled to the interface and operable to:
aggregate the information associated with the company from a plurality of websites in real time without caching any data associated with the information, the plurality of websites comprising:
a website associated with the company;
a website associated with a government entity; and
a website associated with a public entity;
analyze the information by performing a plurality of calculations using the information, the plurality of calculations comprising a plurality of financial ratios, the plurality of financial ratios comprising at least one of:
a revenue growth ratio;
a net income growth ratio;
an operating income growth ratio;
a gross profit margin ratio;
an operating profit margin ratio;
a net profit margin ratio;
an effective tax rate ratio;
a return on assets ratio;
a return on equity ratio;
a net working capital ratio;
a current ratio;
a quick ratio;
a cash ratio;
a debt ratio;
a debt to equity ratio;
an interest coverage ratio;
a cash flow to debt ratio;
an operating cash flow to sales ratio;
a free cash flow to operating cash ratio;
a short term debt coverage ratio; and
a capital expenditure coverage ratio; and
categorize the plurality of news stories into one or more of a plurality of news categories, the plurality of news categories comprising:
an earnings release category;
a merger category;
an acquisition category;
an executive category;
an award category; and
a new contract category;
create a profile associated with the company based on the information; and
the interface further operable to communicate the profile associated with the company to the user.

2. A system, comprising:
an interface operable to receive a request from a user to obtain information associated with a company;
a processor communicatively coupled to the interface and operable to:
aggregate the information associated with the company from a plurality of websites in real time without caching any data associated with the information, the information comprising a news story associated with the company;
analyze the information by performing a plurality of calculations using the information, the plurality of calculations comprising a plurality of financial ratios;
categorize the news story associated with the company into one or more of a plurality of news categories; and
create a profile associated with the company based on the information; and
the interface further operable to communicate the profile associated with the company to the user.

3. The system of claim 2, wherein the information associated with the company comprises:
a description of the company;
a list of executives of the company;
a stock price of the company;
a list of competitors of the company, the list comprising a competitor name and a corresponding market share for each competitor according to a particular business segment; and
a plurality of financial data associated with company.

4. The system of claim 2, wherein the plurality of news categories comprise:
an earnings release category;
a merger category;
an acquisition category;
an executive category;
an award category; and
a new contract category.

5. The system of claim 2, wherein the plurality of websites comprise:
a website associated with the company;
a website associated with a government entity; and
a website associated with a public entity.

6. The system of claim 5, wherein the information is aggregated from the website associated with the government entity based on a ticker symbol of the company.

7. The system of claim 2, wherein the plurality of financial ratios comprise at least one of:
a revenue growth ratio;
a net income growth ratio;
an operating income growth ratio;
a gross profit margin ratio;
an operating profit margin ratio;
a net profit margin ratio;
an effective tax rate ratio;
a return on assets ratio;
a return on equity ratio;
a net working capital ratio;
a current ratio;
a quick ratio;
a cash ratio;
a debt ratio;
a debt to equity ratio;
an interest coverage ratio;
a cash flow to debt ratio;
an operating cash flow to sales ratio;
a free cash flow to operating cash ratio;
a short term debt coverage ratio; and
a capital expenditure coverage ratio.

8. The system of claim 2, wherein the plurality of websites are predefined by an administrator.

9. A non-transitory computer readable medium comprising logic, the logic, when executed by a processor, operable to:
receive a request from a user to obtain information associated with a company;
aggregate the information associated with the company from a plurality of websites in real time without caching any data associated with the information, the information comprising a news story associated with the company;
analyze the information by performing a plurality of calculations using the information, the plurality of calculations comprising a plurality of financial ratios;
categorize the news story associated with the company into one or more of a plurality of news categories;
create a profile associated with the company based on the information; and
communicate the profile associated with the company to the user.

10. The computer readable medium of claim 9, wherein the information associated with the company comprises:
a description of the company;
a list of executives of the company;
a stock price of the company;
a list of competitors of the company, the list comprising a competitor name and a corresponding market share for each competitor according to a particular business segment; and
a plurality of financial data associated with company.

11. The computer readable medium of claim 9, wherein the plurality of news categories comprise:
an earnings release category;
a merger category;
an acquisition category;
an executive category;
an award category; and
a new contract category.

12. The computer readable medium of claim 9, wherein the plurality of websites comprise:
a website associated with the company;
a website associated with a government entity; and
a website associated with a public entity.

13. The computer readable medium of claim 12, wherein the information is aggregated from the website associated with the government entity based on a ticker symbol of the company.

14. The computer readable medium of claim 9, wherein the plurality of financial ratios comprise at least one of:
a revenue growth ratio;
a net income growth ratio;
an operating income growth ratio;
a gross profit margin ratio;
an operating profit margin ratio;
a net profit margin ratio;
an effective tax rate ratio;
a return on assets ratio;
a return on equity ratio;
a net working capital ratio;
a current ratio;
a quick ratio;
a cash ratio;
a debt ratio;
a debt to equity ratio;
an interest coverage ratio;
a cash flow to debt ratio;
an operating cash flow to sales ratio;
a free cash flow to operating cash ratio;
a short term debt coverage ratio; and
a capital expenditure coverage ratio.

15. A method, comprising:
receiving a request from a user to obtain information associated with a company;
aggregating, by one or more processing devices, the information associated with the company from a plurality of websites in real time without caching any data associated with the information, the information comprising a news story associated with the company;
analyzing, by the one or more processing devices, the information by performing a plurality of calculations using the information, the plurality of calculations comprising a plurality of financial ratios;
categorizing, by the one or more processing devices, the news story associated with the company into one or more of a plurality of news categories;
creating a profile associated with the company based on the information; and
communicating the profile associated with the company to the user.

16. The method of claim 15, wherein the information associated with the company comprises:
a description of the company;
a list of executives of the company;
a stock price of the company;
a list of competitors of the company, the list comprising a competitor name and a corresponding market share for each competitor according to a particular business segment; and
a plurality of financial data associated with company.

17. The method of claim 15, wherein the plurality of news categories comprise:
an earnings release category;
a merger category;
an acquisition category;
an executive category;
an award category; and
a new contract category.

18. The method of claim 15, wherein the plurality of websites comprise:
a website associated with the company;
a website associated with a government entity; and
a website associated with a public entity.

19. The method of claim 18, wherein the information is aggregated from the website associated with the government entity based on a ticker symbol of the company.

20. The method of claim 15, wherein the plurality of financial ratios comprise at least one of:
a revenue growth ratio;
a net income growth ratio;
an operating income growth ratio;
a gross profit margin ratio;
an operating profit margin ratio;
a net profit margin ratio;
an effective tax rate ratio;
a return on assets ratio;
a return on equity ratio;
a net working capital ratio;
a current ratio;
a quick ratio;
a cash ratio;
a debt ratio;
a debt to equity ratio;
an interest coverage ratio;
a cash flow to debt ratio;
an operating cash flow to sales ratio;
a free cash flow to operating cash ratio;
a short term debt coverage ratio; and
a capital expenditure coverage ratio.

21. The method of claim 15, wherein the plurality of websites are predefined by an administrator.

22. The method of claim 15, further comprising:
receiving a second request from the user for raw data associated with at least a portion of the information; and
communicating the raw data to the user.
